(19) United States
(12) Patent Application Publication
(10) Pub. No.: US 2016/0335139 A1
(43) Pub. Date: Nov. 17, 2016

(54) ACTIVITY TRIGGERS

(71) Applicant: Google Inc., Mountain View, CA (US)

(72) Inventors: Fergus Gerard Hurley, San Francisco, CA (US); Robin Dua, San Francisco, CA (US)

(21) Appl. No.: 14/708,642

(22) Filed: May 11, 2015

(51) Int. Cl. G06F 9/54; G06F 3/0484

(52) U.S. Cl. CPC G06F 9/542; G06F 3/04842

(57) ABSTRACT

Methods, systems, and apparatus, including computer programs encoded on a computer storage medium, for action items, user defined actions, and triggering activities. In one aspect, a method includes receiving, at a user device, input of a user defined action, the user defined action including a plurality of terms; receiving, by the user device, a selection of a user defined trigger activity, the trigger activity indicating user performance of an activity to trigger the user defined action to be presented; determining at least one environmental condition of an environment in which the user device is located; determining, based on user information and the at least one environmental condition, a user performance of the activity indicated by the trigger activity; and presenting, by the user device, a notification of the user defined action to the user device of the user.

### BACKGROUND

The advent of cloud based services, search engines, and other services and media has drastically expanded the utility of user devices over the last decade. Many user devices, especially mobile devices and smart phones, now provide services and applications in addition to voice and data access. Furthermore, with the recent advances in processing systems, many users now want fluid and intuitive user experiences with their user devices.

Many of these application services available to users are instantiated by use of command inputs. One such service is the setting of actions (e.g., reminders). For example, a user may speak (or type) the input [remind me to buy milk this evening] into a smart phone, and the smart phone, using a command parsing application (or, alternatively, communicating with a command parsing service) will invoke an action process that may solicit additional information from the user. Such information may include a time, if the user desires to be reminded at a certain time, and/or a location, if the user desires to be reminded when the user arrives at the location. While the setting of such actions is very useful and a relatively fluid user experience, the users often forget to do the things they wanted to do because they cannot setup reminders that are based on the context that they need to be in to be able to complete the task at hand.

### SUMMARY

This specification relates to action items, user defined actions, and trigger activities.

In general, one innovative aspect of the subject matter described in this specification can be embodied in a method that includes the actions of receiving, at a user device, input of a user defined action, the user defined action including a plurality of terms; receiving, by the user device, a selection of a user defined trigger activity, the trigger activity indicating user performance of an activity to trigger the user defined action to be presented; determining at least one environmental condition of an environment in which the user device is located; determining, based on user information and the at least one environmental condition, a user performance of the activity indicated by the trigger activity; and presenting, by the user device, a notification of the user defined action to the user device of the user. Other embodiments of this aspect include corresponding systems, apparatus, and computer programs, configured to perform the actions of the methods, encoded on computer storage devices.

Particular implementations of the subject matter described in this specification can be implemented so as to realize one or more of the following advantages. Implementations of the subject matter described below allows for an intuitive and more accurate user experience when creating actions and being notified of actions (e.g., reminders). The selection by the user of one or more activity they would like to be performing when they are provided with a user defined action, like a reminder, allows for the user to customize and reminder them of tasks when it is more likely they will have the time, resources, or other means to accomplish the user defined action.

For example, if the user selects a user defined action of [buy juice] when they are [driving], the user is in their vehicle where they can make a trip to the store while they are out. In many situations this frees the user from having to specify a particular time or search for a particular location for an activity trigger. This reduces the necessity of a user to keep a particular schedule, and can accomplish providing users of user defined actions at flexible, yet appropriate, times when the system determines there is user performance of an activity that makes it more likely they will have the time, resources, or other means to accomplish the user defined action.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which in which command inputs are processed for user defined actions and activity triggering.

FIG. 2 is a flow diagram of an example process for creating and being notified of a user defined action when a trigger activity is determined to be performed.

FIG. 3A is an illustration of a user interface at a user device in which a user defined action is created.

FIG. 3B is an illustration of a user interface at a user device where the user creates an action limitation by selecting in the area of the action limitation.

FIG. 3C is an illustration of a user interface at a user device where a trigger activity list is provided.

FIG. 3D is an illustration of a user interface at a user device where a trigger activity is presented under a user defined action.

FIG. 4A is an illustration of a user interface at a user device in which an activity condition is created.

FIG. 4B is an illustration of a user interface at a user device in which an activity condition has been added to the action item.

FIG. 5 is an illustration of a user interface at a user device in which a list of user defined actions are provided.

FIG. 6 is a flow diagram of an example process for determining at least one environmental condition based on environments at different time periods.

FIG. 7 a flow diagram of an example process for using a confidence score and confidence score threshold for determining user performance of the trigger activity.

FIG. 8 is a block diagram of an example mobile computing device.

Like reference numbers and designations in the various drawings indicate like elements.

### DETAILED DESCRIPTION

An action processing system facilitates the creation of user defined actions and trigger activities. In operation, the action processing system receives an input set of terms from the user that describe a user defined action. The user can select one or more trigger activities that indicate an activity to be performed by the user to trigger the user defined action to be presented to the user. Additionally, the user can select one or more activity conditions that indicate a condition to be satisfied in determining that the user has performed the activity indicated by the trigger activity. For example, a user may select a user defined action of “Call Larry” with a trigger activity of “Walking” The user defined action would not be triggered to be presented to the user on the user device until the action processing system determined the user was “walking” Further, in some implementations, the activity trigger may include additional situational information to trigger the user defined action. For example, based on the previous example, the activity trigger could include walking to a specific place (e.g., walking home or walking to the grocery store). Based on environmental conditions, a user history and a user context, further described below, the action processing system can determine if there has been user performance of the activity trigger.

Additionally, based on the previous example above, users may create activity conditions that need to be satisfied in addition to the activity being satisfied. An example activity condition could be a time period of “Saturday afternoon.” Therefore, based on including the activity condition, the user defined action would not be triggered to be presented to the user until the action processing system determined the user was “walking” on “Saturday afternoon.”

In order to determine if there is user performance of the trigger activity, the action processing system can evaluate at least one environmental condition of the user, for example, based on the user's user device. The environmental conditions may be analyzed by sensors associated with the user device or action processing system, and can include, for example, sensors to monitor movement and speed, air speed, light and light variability, temperature, humidity, altitude, noise level and noise variation, among others.

Additionally, the action processing system can analyze user information to determine user performance of the trigger activity. As used herein, user information is information that that is used in conjunction with sensed environmental data to determine user performance of the trigger activity. The user information is information that is collected or received from sources other than the sensors that generator the sensor data. For example, the user information can include a user history that comprises past user data. For example, the user history may include previous actions, activities, and locations for the user associated with the user device.

Also, the user information can include user context that indicates current user data, which may include the weather and location of the user device, and the user's calendar that is on the user device and/or another device of the user's. For example, if the weather data from a weather service for the location of the user device indicates the temperature is 50 degrees Fahrenheit and the sensors used to determine the environmental conditions surrounding the user device indicate the temperature is 72 degrees Fahrenheit, the action processing system can use this user information and sensor data to determine the user device 106 of the user is indoors.

The action processing system can be implemented in the user device, or in a computer system separate from user device, such as a server system. In the case of the latter the server system receives input from the user device and sends data to the user device for processing and setting action items. These features and additional features are described in more detail below.

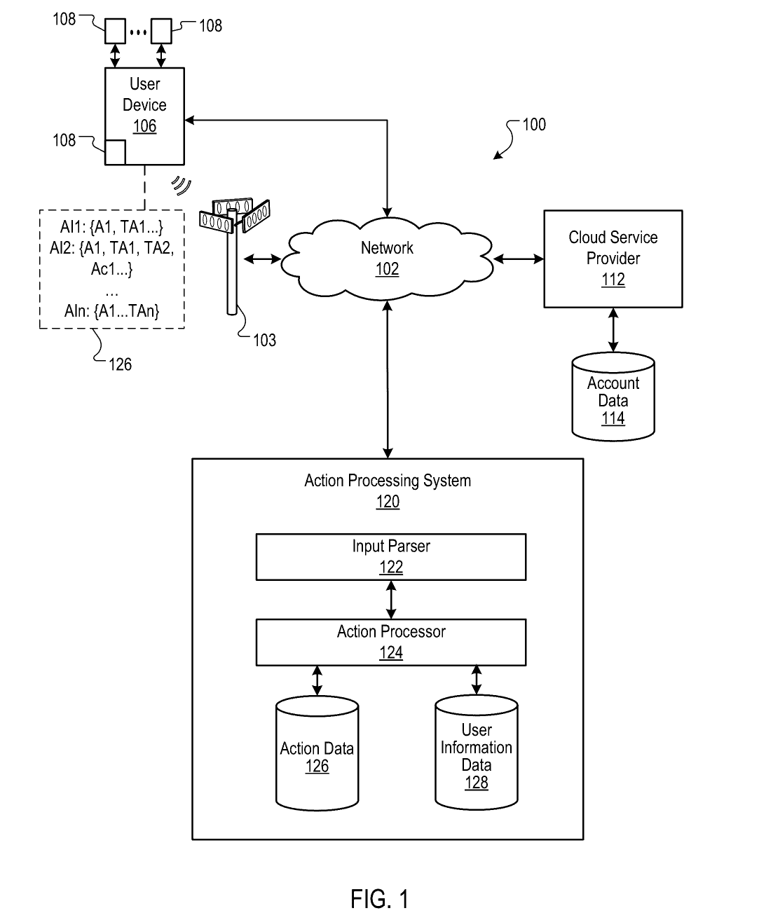

FIG. 1 is a block diagram of an environment 100 in which command inputs are processed for action items, user defined actions, and trigger activities. A computer network 102, such as the Internet, or a combination thereof, provides for data communication between electronic devices and systems. The computer network 102 may also include, or be in data communication with, one or more wireless networks 103 by means of one or more gateways.

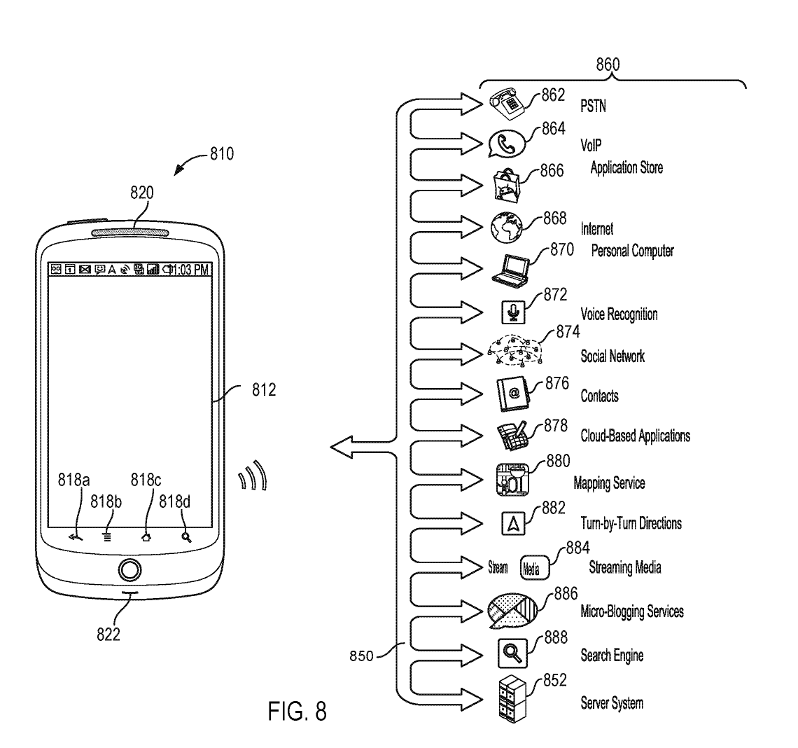

User device 106 is an electronic device that is under the control of a user and is capable of requesting and receiving resources over the network 102, establishing communication channels, e.g., voice communications, with other user devices, and also capable of performing other actions. Example user devices 106 include personal computers, mobile communication devices, and other devices that can send and receive data over the network 102. In the example of FIG. 1, the user device 106 is a smart phone. An example smart phone is described with reference to FIG. 8 below. The user device 106 may communicate over the networks 102 and 103 by means of wired and wireless connections with the networks 102 and 103. As described with reference to FIG. 8, a user device may be able to perform a set of device actions for various programs and capabilities.

The user device 106 is associated with a user account, such as an account hosted by a cloud service provider 112 that provides multiple services. These services may include web mail, social networking, messaging, documents storage and editing, an electronic assistant service etc. The account data 114 may store data specific to the account of the user device 106. Further, although only one user device 106 is shown in FIG. 1, a plurality of user devices 106 may be included.

An action processing system 120 receives command inputs from user devices and processes the inputs to determine which, if any, actions are to be taken in response to the input. While the action processing system 120 is shown as a separate entity in FIG. 1, the action processing system 120 can be implemented in the cloud service provider 112, or even in the user device 106.

Inputs may invoke various actions, as determined by the action processing system 120. For example, an input may be interpreted as a search query command, in which case a search query is sent to a search service. Likewise, an input may be interpreted as a command to place a phone call, in which case the user device 106 attempts to establish a voice communication over the network 103. Likewise, an input may be interpreted as a user defined action, in which case an action item with a user defined action may be generated. The generation of action items, user defined actions, and the processing of such items are described in more detail below.

In some implementations, each input is processed by an input parser 122, which is programmed to parse the input terms and determine what actions, if any should be taken. In some implementations, the input parser 122 may access language models to determine which commands or actions to take. Such language models may be statistically based, e.g., models may include weights assigned to particular words and phrases that are determined to be semantically relevant to a particular command, or rule-based, e.g., grammars that describe sentence structures for particular commands. A variety of other language and text input processing systems may be used.

As described above, a user may input a command on the user device 106, and the action processing system 120 processes the command input to determine whether the command input resolves to a user device action that the user device is configured to perform. For the remainder of this document, the example inputs that are processed will resolve to action-based inputs. Accordingly, descriptions of other command processing features for other command input types are omitted.

In some implementations, the action processing system 120 includes an action processor 124 that communicates with the input parser 122. The action processor 124 also accesses action data 126 and user information data 128. The action processor 124 can receive user input of a user defined action set by a user on user device 106. The user defined action may be, for example, a reminder to be presented to the user on the user device or an action that may be completed. A user defined action may include a plurality of terms, and may be, for example, “Call Larry,” “Wash Car,” “Clean the House,” or any other action. The action processor 124 will store the user defined action in action data 126 for a particular reminder. There may be a plurality of action items AI1, AI2, . . . AIn stored in action data 126, and each of the plurality of action items may have one or more user defined actions A1, A2, . . . An defined for the action item.

Additionally, each of the plurality of action items may have one or more trigger activities TA1, TA2, . . . TAn associated with the action item. Trigger activities may indicate user performance of an activity to trigger the user defined action to be presented. User performance of an activity may include predicting the user of the user device 106 will perform the trigger activity, the user of the user device 106 is performing the trigger activity, and/or the user of the user device 106 has performed the trigger activity. As discussed below, the user history and the user context can be used to determine and analyze when there is user performance (including future performance) of an action.

Trigger activities may be physical activities or situational activities. Physical activities are activities that may be sensed directly from environmental sensor data, including location data, audio data, accelerometer data. Additionally, the activities may be based on inferences generated by the action processing system 120, which may incorporate information sensed by the environmental sensor data, to infer an activity performed by the user of the user device 106. Examples include walking, driving, biking, running, swimming, among others. Situational activities are activities that may be inferred from environmental sensor data and other data that when combined with the environmental data are indicative of an activity. Examples include reading, watching TV, cooking, in bed, among others. In some implementations, more than one activity may be selected. By way of example, a user may select the trigger activities to be “reading” and “in bed.” However, if a user is able to select more than one activity, the action processor 124 may prevent the user from selecting two or more activities that could not be done at the same time (e.g., “swimming” and “cooking”); however, such a configuration is not required, and in some implementations, the user may provide a sequence of trigger activities to be performed before the user defined action is provided. In some implementations, the trigger activities may be selected from a list provided to the user.

Additionally, in some implementations, a user may provide activity conditions Ac1, Ac2, . . . Acn associated with the one or more trigger activities and user defined actions of each action item. Multiple types of activity conditions may be set for one or more action item. An activity condition specifies, in addition to the activity, a condition to be satisfied in determining user performance of the activity indicated by the trigger activity. For example, activity conditions may be one or more time period condition, location area condition, or person proximity condition, among others. A time period condition may be a date, a date range, a time of day, or a time of day range, among others. For example, AI1 may include a user defined action (A1) of “Call Larry” and a trigger activity (TA1) of “Walking,” and the user may also include an activity condition (Ac1) of “Saturday afternoon,” which may be a default or user set time range (e.g., 1 PM-5 PM) on a particular Saturday (e.g., the next Saturday), every Saturday, selected Saturdays, or a pattern of Saturdays (e.g., the first Saturday of every month). Based on this example of action item AIL the user defined action “Call Larry” (A1) would not be triggered unless user performance of the trigger activity of “walking” (TA1) on “Saturday afternoon,” as defined by activity condition Ac1, is determined. Additionally, as previously described, the activity trigger may be more specific with respect to the activity, and the activity trigger may include a more situational context for the activity (e.g., walking home from work).

A location area condition may be an area around a particular location (e.g., house address) or type of location (e.g., grocery store, airport, hospital) that the user device is to be within or near for the activity condition to be met. For example, the location area condition may be “Near Grocery Store,” which may be defined as a particular grocery store or any grocery store. Additionally, “near” can be a particular distance from (e.g., feet or miles) or amount of time away by different modes of transportation (e.g., by car, public transportation, walking) from the identified location. Thus, if a user defined action is set to be “Buy Groceries” and a trigger activity is set to be “Driving,” the user can select an additional condition of “Near Grocery Store.” The user device would then notify the user of the user defined action, “Buy Groceries,” if the action processor 124 determines the trigger activity is triggered and activity condition is satisfied when the user is near the grocery store, which in the current example includes the user driving near a grocery store. Conversely, if a user is out for a run and is near a grocery store, the user will not be reminded to buy groceries, as the user would very likely not want to carry groceries for a remainder of the user's run.

Additionally, an activity condition may be a person proximity condition. A person proximity condition may be met if the user device 106 of the user is within a certain distance from an identified user device of a particular person or group. In some implementations, the distance of the user device 106 from an identified user device may be provided by the action processor 124 or the user may be able to adjust the distance. Further, in some implementations, for the action processor 124 to recognize the user devices of the particular person or group, the user device 106 may need to include the particular person or group as a contact or otherwise identify the person or group. However, in other implementations, the action processor 124 can identify user devices of particular people and groups around the user device 106. For example, the user may create an action item that includes a user defined action of “Discuss vacation,” a trigger activity of “eating dinner,” and a person proximity condition of “David.” The user device 106 would then notify the user to “Discuss vacation” when the action processor 124 determines the user is “cooking” and is with “David.” Additionally, the user may also include a time period condition and/or a location area condition.

The user device 106 can determine environmental conditions of an environment in which the user device is located and, from the sensed data, can determine whether certain activities are being performed. In some implementations, the user device 106 may include sensors 108 that can evaluate the surrounding environment. For example, sensors 108 may monitor movement and speed (e.g., using an accelerometer), air speed, light and light variability, temperature, humidity, altitude, noise level and noise variation, among others. Sensors 108 may be within the interior and/or on the exterior of user device 106, and the sensors 108 may communicate the data sensed by the sensors 108 to the user device 106 and/or the action processor 124. Sensors 108 can continuously or periodically monitor the surrounding environment of user device 106.

The surrounding environment can be evaluated based on individual data detections by the sensors 108 and/or data detections by the sensors 108 at different times. For example, if the sensors 108 detect movement of the user device 106 travelling at 7 miles per hour with bright lighting, and a temperature of 70 degrees, the sensors 108 can provide the data detected the user device 106 and/or action processor 124 to evaluate the environmental conditions of the user associated with the user device. For the environmental conditions provided above, the user device 106 and action processor 124 can use that information, along with the user information, to determine, for example, the user associated with the user device 106 is running outdoors. In some implementations, environmental conditions may be determined by a component of action processing system 120 or any other device or component that can detect environmental conditions and is in communication with the action processing system 120 or the user device 106. For example, in some implementations, sensors 108 may be included in different components that are able to sense and determine information and activities of a user.

Additionally, as previously mentioned, detection data of the sensors 108 at different times may be used and combined to determine the environmental conditions of the user device 106. For example, at a first time, the sensors 108 may detect no movement by the user device 106, a high level of artificial light, and a low noise level. At a second time (e.g., ten minutes after the first time), the sensors 108 may detect no movement by the user device 106, a low level of artificial light, and a high noise level. This sensor data from the different times may be provided to the user device 106 and/or action processor 124 to determine the environmental conditions of the user associated with the user device 106. Based on the example above, the user device 106 and/or action processor 124 may determine the environmental conditions of the user device included a stationary user device 106 between the first time and the second time, and there was variability in artificial lighting and noise level. For the environmental conditions provided above, the user device 106 and/or action processor 124 can use that information, along with the user information, to determine, for example, the user associated with the user device 106 is watching television.

User information of the user associated with user device 106 may be determined from user information data 128, user device 106, or other information associated with the user that may also be included with the user information data 128 and/or user device 106 (e.g., location, weather, calendar). User information can be determined from a user history and a user context.

For example, the user history may include data describing previous actions, activities, and locations for the user associated with the user device 106. The user history information can be used by the action processor 124 to determine interests, preferences, schedules, and patterns of the user associated with the user device 106. For example, if the user walks with a user device 106 for approximately thirty minutes after waking up on a number of occasions, the action processor 124 can use that pattern information in its trigger activity analysis. Therefore, if the trigger activity is, for example, “walking” and the analysis time is in the morning, the action processor 124 can factor the user pattern into the analysis of determining if the user is walking with the user device 106 at that time. The user history may also include actions the user has performed on the user device 106 and/or a level of activity for user device 106 applications and times that applications are used on the user device 106. Additionally, other information can be obtained from and included in the user history.

The user context includes current user data, which may include the weather and location of the user device 106, and the user's calendar that is on the user device 106 and/or another device of the user's. For example, if the weather in the location of the user device 106 indicates the temperature is 50 degrees Fahrenheit and the sensors 108 used to determine the environmental conditions surrounding the user device 106 indicate the temperature is 72 degrees Fahrenheit, the action processor 124 can use that information to determine the user device 106 of the user is indoors. Additionally, the user context may include actions the user is performing on the user device 106 and/or applications that are opened or being used on the user device 106.

The user context may include, for example, data indicating content in a browser of the user device 106 (e.g., a recipe), or the user context may indicate that a reading application is open in the user device 106. Moreover, a distinction may be made in the user context in determining whether an application is currently in the user device's 106 viewport or in the background of the user device's 106 viewport. For example, if the user context includes the user device 106 having a webpage open with a recipe in the viewport of the user device 106, the user context can provide this user information to the action processor 124 to perform the trigger activity analysis. Based on the previous example, if the trigger activity is “cooking,” the action processor 124 can include the user information and environmental conditions to determine if the user associated with the user device 106 has triggered the trigger activity. Moreover, the user history and user context may be used to determine if there is user performance of a trigger activity, and inferences may be made based on current user actions detected by sensors 108 and the user context and past activity and actions of the user history.

Further, in some implementations, to determine if there has been user performance of the trigger activity, a confidence score may be determined for indicating a level of confidence that the trigger activity was performed. For example, a confidence score may be determined for the trigger activity of “cooking” by the action processor 124 when the user context includes the user device 106 having a webpage open (or opening) with a recipe in the viewport of the user device 106. A higher confidence score may be determined if the user calendar on the user device 106 indicates, for example, the user is scheduled to make dinner with “Larry” at this particular time. Moreover, an even higher confidence score could be determined if a person proximity condition related to “Larry” were included in the action item, and the action processor 124 determines that the user device of “Larry” is within the proximity range of the user device 106 associated with the user. Also, in some implementations, in order to determine user performance of the trigger activity, a threshold confidence score may be defined by the action processor 124, which may be adjusted or modified by the action processor 124 or the user of the user device.

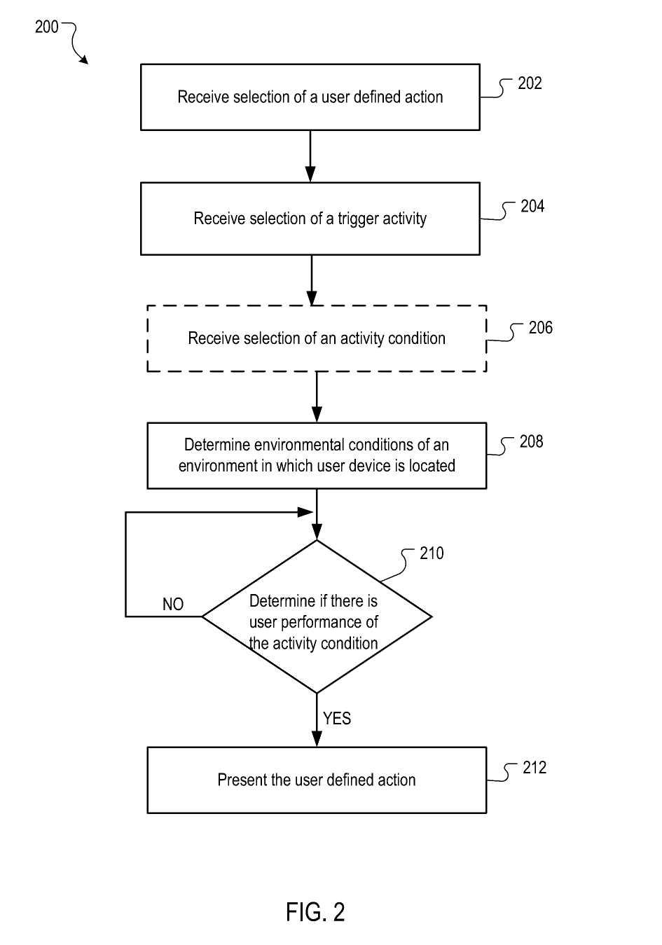

FIG. 2 is a flow diagram of an example process 200 for creating and being notified of a user defined action when user performance of a trigger activity has occurred. The process 200 can, for example, be implemented by a user device 106 and/or the action processor 124. In some implementations, the operations of the example process 200 can be implemented as instructions stored on a non-transitory computer readable medium, where the instructions cause a data processing apparatus to perform operations of the example process 200.

Input of a user defined action is received at the user device 106 (202). The action processor 124 can receive user input of a user defined action set by a user on user device 106. The user defined action is what the user would like to be reminded of or performed when user performance of the trigger activity is determined. A user defined action may be a reminder and may include a plurality of terms, and may be, for example, “Call Larry,” “Wash Car,” “Clean the House,” or any other task the user would like to be reminded of or performed. The action processor 124 will store the user defined action in action data 126 for a particular action item.

A selection of a user defined trigger activity is received at the user device 106 (204). Trigger activities indicate an activity to be performed by the user to trigger the user defined action. Trigger activities may be physical activities or situational activities. In some implementations, more than one activity may be selected.

In some implementations, an activity condition can be selected at the user device 106 (206). An activity condition indicates a condition to be satisfied in determining that the user has performed the activity indicated by the trigger activity. For example, activity conditions may be, as previously described, one or more time period condition, location area condition, or person proximity condition.

Environmental conditions of an environment in which the user device is located is determined (208). In some implementations, the user device 106 may include sensors 108 that can evaluate the surrounding environment. For example, sensors 108 may monitor movement and speed (e.g., using an accelerometer), air speed, light and light variability, temperature, humidity, altitude, noise level and noise variation, among others. The surrounding environment can be evaluated based on individual data detections by the sensors 108 and/or data detections by the sensors 108 at different times. The environmental conditions can be provided to the action processor 124, in some implementations.

Next, the method determines, based on user information and the environmental conditions, whether there has been user performance the activity indicated by the trigger activity (210). In the analysis of determining whether the trigger activity has been performed, user information may be included, which may be obtained from user information data 128, user device 106, or other information associated with the user that may also be included with the user information data 128 and/or user device 106 (e.g., location, weather, calendar). User information can be determined from a user history and a user context. Additionally, user performance of an activity may include predicting the user of the user device 106 will perform the trigger activity, the user of the user device 106 is performing the trigger activity, and/or the user of the user device 106 has performed the trigger activity.

The user history may include past user data. For example, the user history may include previous actions, activities, and locations for the user associated with the user device 106. The user history information can be used by the action processor 124 to determine interests, preferences, schedules, and patterns of the user associated with the user device 106. Additionally, other information can be obtained from and included in the user history.

Further, user context may be included in the user information. The user context includes current user data, which may include the weather and location of the user device 106, and the user's calendar that is on the user device 106 and/or another device of the user's. Additionally, the user context may include actions the user is performing on the user device 106 and/or applications that are opened or being used on the user device 106. The user context may include, for example, data indicating content in a browser of the user device 106 (e.g., a recipe), or the user context may indicate that a reading application is open in the user device 106.

After determining user performance of the trigger activity, the user defined action may be presented to the user device 106 of the user, as described below (212). The user defined action may also have an alarm associated with the notification. Additionally, in some implementations, the user device 106 or action processing system 120 may perform the user defined action. For example, if the user defined action is “Turn on air conditioner” and the trigger activity is “driving home.” The user device 106 or action processing system 120 may perform the action of turning on the air conditioner when user performance of “driving home” is determined. The user defined action may be presented to the user for selection to complete the user defined action when user performance of the trigger activity is determined, or in other implementations, the user defined action may automatically be performed. Additionally, user history may be used to determine the temperature to set the air conditioner to.

If the user defined action is performed by the user device 106 or action processing system 120, then a notification may be presented to the user of the user device 106 that the user defined action has been performed. However, if the trigger activity has not been performed, the process may continue to perform step 210. Moreover, in some implementations, the presentation of the user defined action may be provided to a device other than user device 106. For example, the presentation may be provided to a device that is determined to be close to the user or a device that the user will see or is looking at. For example, if the user device 106 of the user is not currently visible to the user, but the user is viewing another device, the action processing system 120 may determine to present the user defined action to the device the user is viewing.

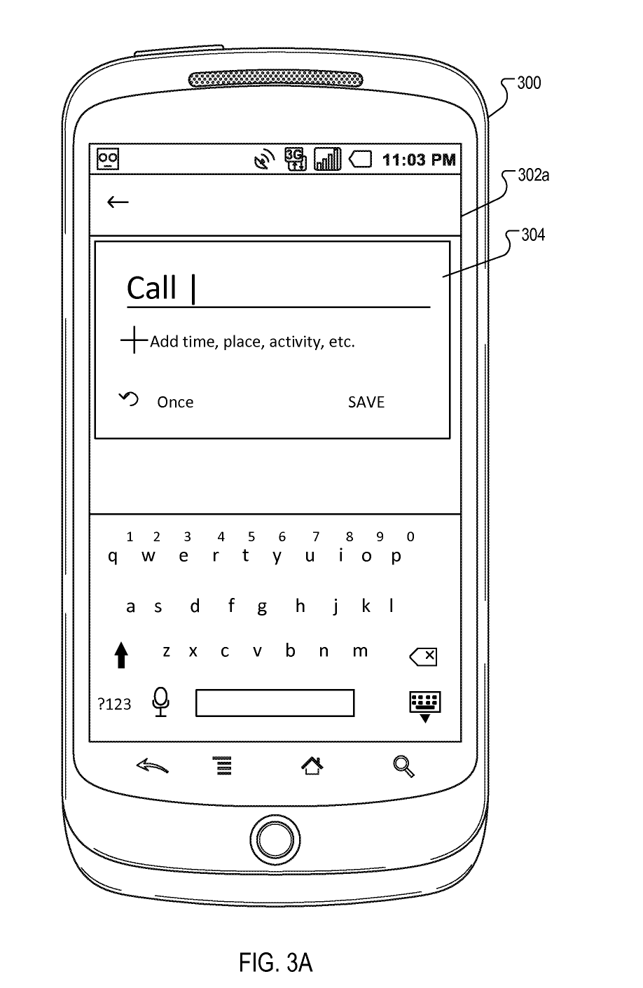

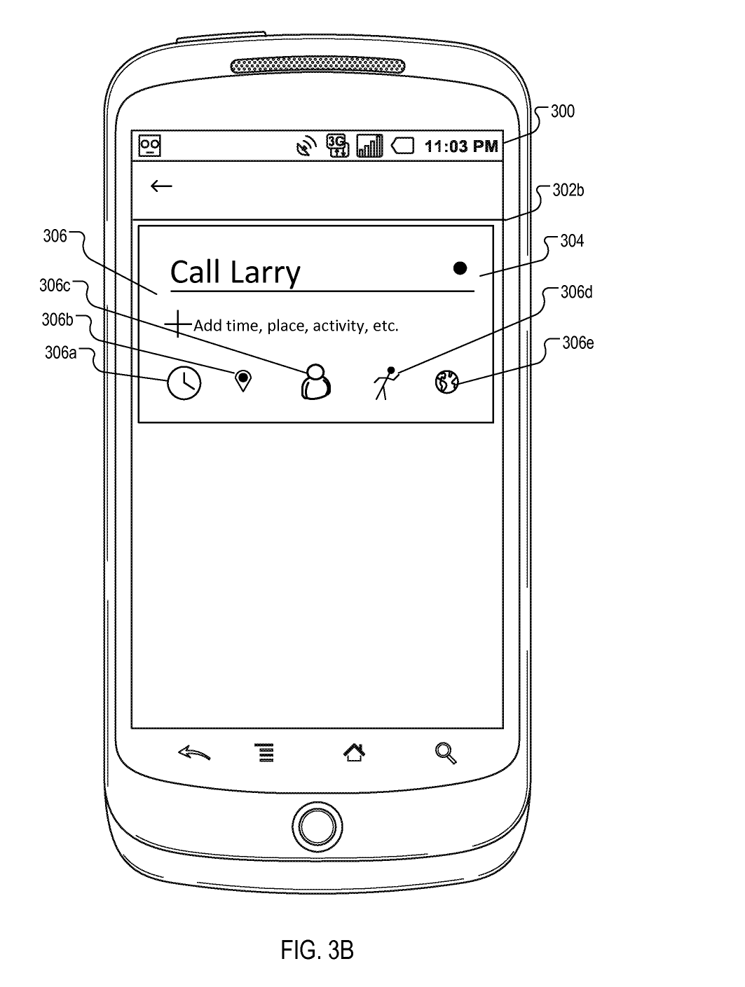

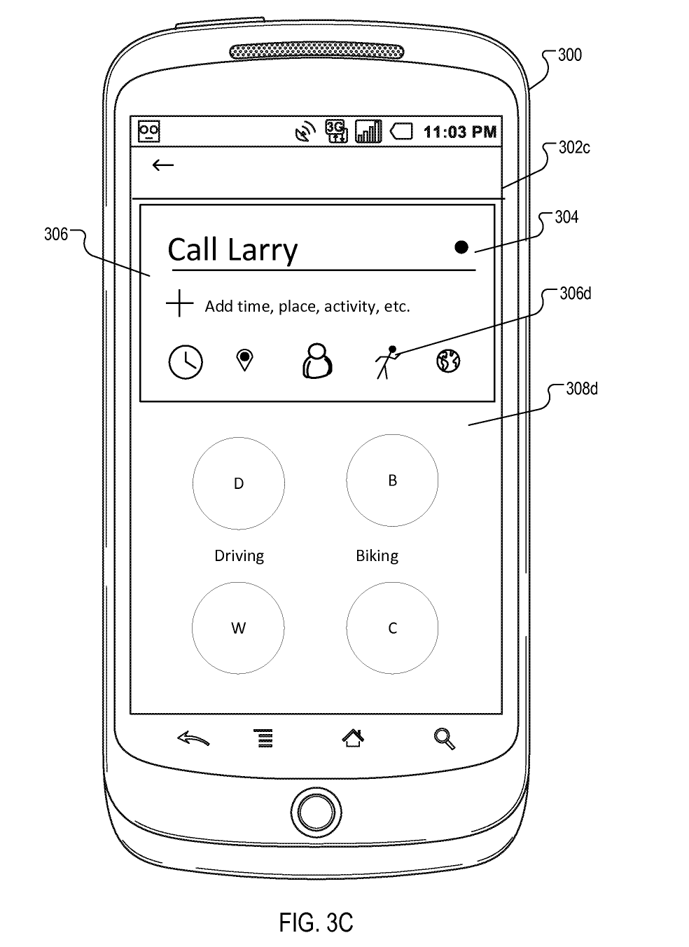

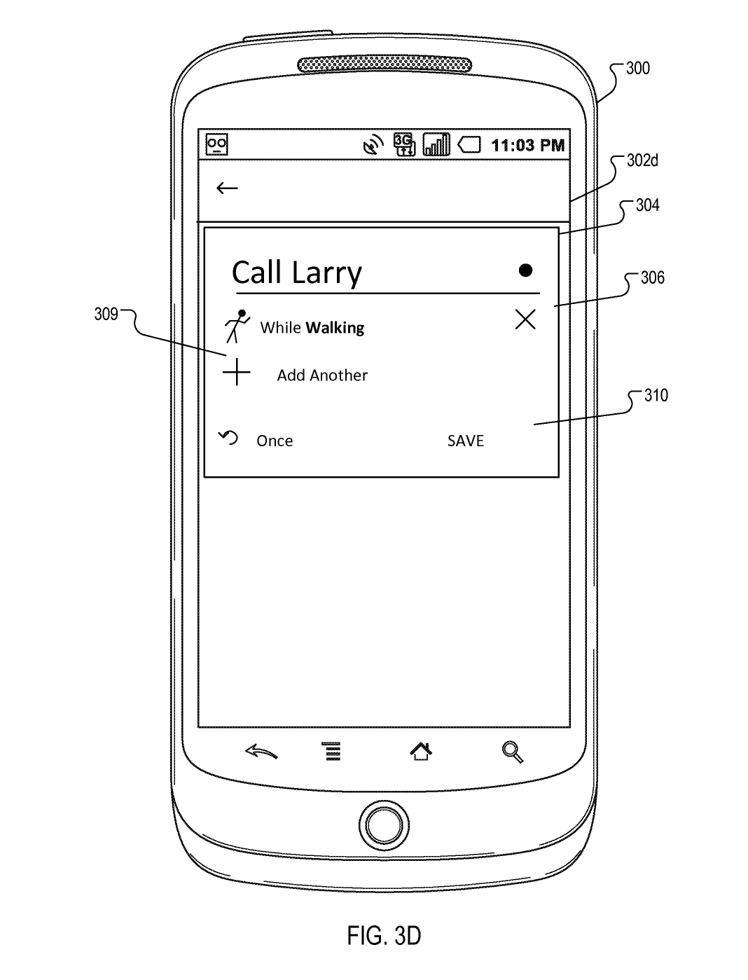

The process 200 may be subject to user confirmation, and is also described in the context of FIGS. 3A-3D. In particular, FIG. 3A is an illustration of a user interface 302a at a user device 300 in which a user defined action is created. At user defined action input field 304, the user may enter the user defined action that the user would like to be presented with when user performance of the trigger activity is determined. In FIG. 3A, the user defined action is in the process of being input into the user defined action input field 304. On the current user device 300, the user may use a touch screen of the user device 300 to enter the terms and characters for the user defined action. However, such a configuration is not required, and other methods and user device types may be used to input characters and terms.

In FIG. 3B, a user interface 302b is provided where the user defined action has been input in the user defined action input field, and the user can create an action limitation by selecting in the area of the action limitation 306. After selecting in the area of the action limitation 306, the user is presented with limitation options, which in the current implementation include time period condition 306a, a location area condition 306b, a person proximity condition 306c, a trigger activity 306d, and a world knowledge option 306e. However, such limitation options are not required, and different and/or more or fewer limitation options may be provided.

Further, in FIG. 3C, a user interface 302c is provided where after the user selects the trigger activity 306d, a trigger activity list 308d may be provided. The trigger activity list 308d, in the current implementation, includes a graphical representation for each activity along with text indicating the activity. For example, the trigger activity list 308d includes the activities of “Driving,” “Biking,” “Walking,” “Watching TV,” and other activities may be provided as the user scrolls down within the trigger activity list 308d on the user device 300. However, such a trigger activity list 308d is not required, and different types of lists may be provided including different activities and different list layouts.

In FIG. 3D, a user interface 302d is provided where after the user selected the trigger activity of “Walking,” the action limitation 306 includes the trigger activity of “Walking” below the user defined action of “Call Larry” in the user defined action input field 304. Additionally, the user may add additional action limitations, as seen by the add action limitation option 309 in the action limitation 306 to “Add another.” The user may indicate the action item is complete by, for example, selecting the save option 310, or other options may be provided for completing the action item.

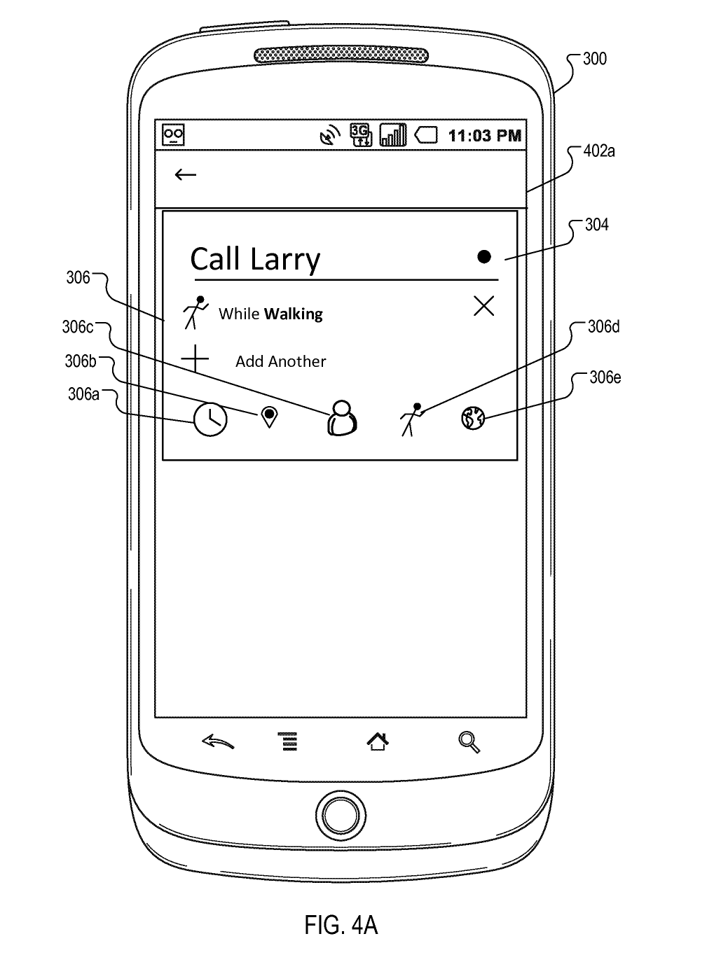

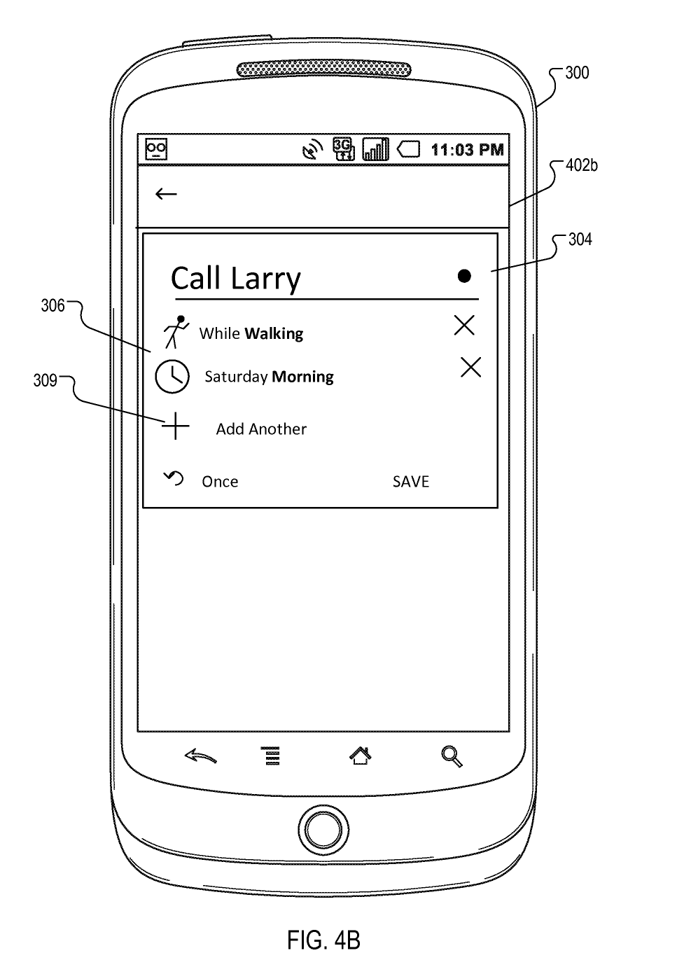

As seen in FIG. 4A, user interface 402a is provided where if the user selects the add action limitation option 309 (seen in FIG. 3D), then the user may be presented with the limitations options, as also seen and described in FIG. 3B. FIGS. 4A and 4B provide a description of adding an activity condition, as seen in process 200 in optional step 206 and described above. If the user selects the time period condition 306a of the limitation options, then the user may select a time period that the trigger activity must be performed within in order to trigger presenting the user defined action to the user of the user device. The time period may be, for example, a time of day (e.g., morning, afternoon, evening), a time range within the day (e.g., 2 PM-5 PM), a particular day (e.g., Saturday or Mar. 1, 2015), a recurring time period, date, or range of dates (e.g., the first Saturday of every month), or a range of days (e.g., Mar. 1, 2015-Apr. 15, 2015), among others.

As seen in FIG. 4B, user interface 402b is provided where the user has selected a day, “Saturday,” and a time period “Morning.” As such, in the current example, the user must perform the trigger activity, “Walking,” during the time period condition, “Saturday Morning,” in order for the user defined action, “Call Larry” to be presented to the user of the user device. Additionally, as described in FIG. 3D, the user may add additional action limitations by selecting the add action limitation option 309.

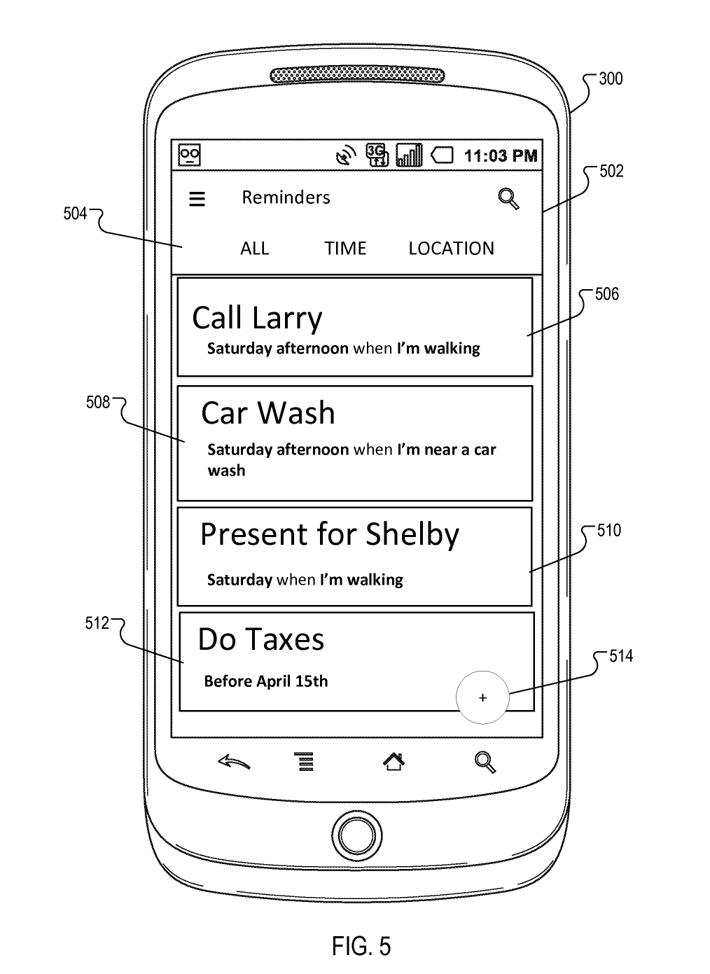

FIG. 5 is an illustration of a user interface 502 at a user device 300 in which a list of action items are provided. The list of action items may be filtered based on the filters 504. In the current implementation, filters 504 include “ALL,” “TIME,” and “LOCATION.” However, in other implementations, different filters and more or fewer filters may be provided. Also, action items 506, 508, 510, and 512 are provided in the current implementation. Action item 506 includes the user defined action, trigger activity, and activity condition that were created and defined in FIGS. 3A-4B. Additionally, an action item may be created from user interface 502 by selecting the add action option 514. In some implementations, by selecting the add action option 514, the user may be directed to the user interface 302 provided in FIG. 3A.

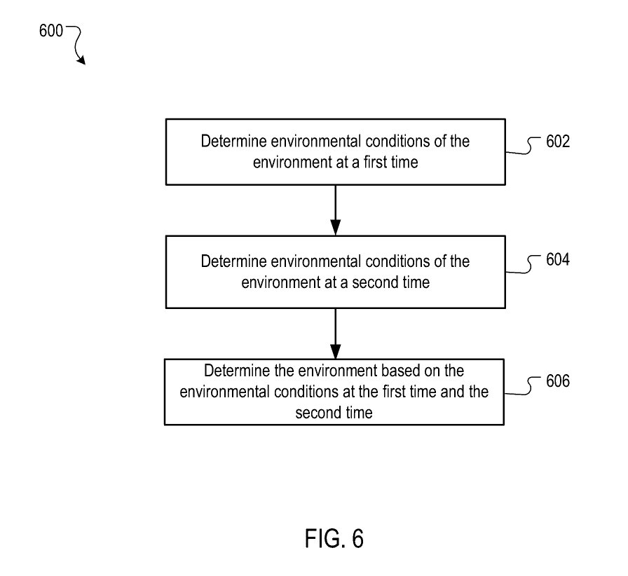

FIG. 6 is a flow diagram of an example process 600 for determining environmental conditions of an environment in which a user device is located based on environmental conditions at different time periods. The process 600 can, for example, be implemented by the user device 106 and/or action processor 124. In some implementations, the operations of the example process 600 can be implemented as instructions stored on a non-transitory computer readable medium, where the instructions cause a data processing apparatus to perform operations of the example process 600.

At a first time, environmental conditions in which the user device 106 is located is determined (602). As discussed above, detection data of the sensors 108 at different times may be used and combined to determine the environmental conditions of the user device 106. For example, at a first time, the sensors 108 may detect no movement by the user device 106, a high level of artificial light, and a low noise level.

At a second time (e.g., five minutes after the first time), environmental conditions in which the user device 106 is located is determined (604). For example, at the second time, the sensors 108 may detect no movement by the user device 106, a low level of artificial light, and a high noise level. Based on the environmental conditions of the first time and the second time, the environmental conditions of the environment in which the user device 106 is located may be determined (606). The sensor data from the different times, which may be more than a first time and a second time, can detect changes and variability of the environmental conditions of the user associated with the user device 106, which may assist in determining activities of the user. For example, based on the sensor data above, the user device 106 and/or action processor 124 may determine the environmental conditions of the user device included a stationary user device 106 between the first time and the second time and variability in artificial lighting and noise level. For the environmental conditions provided above, the user device 106 and/or action processor 124 can use that information, along with the user information, to determine, for example, the user associated with the user device 106 is watching television.

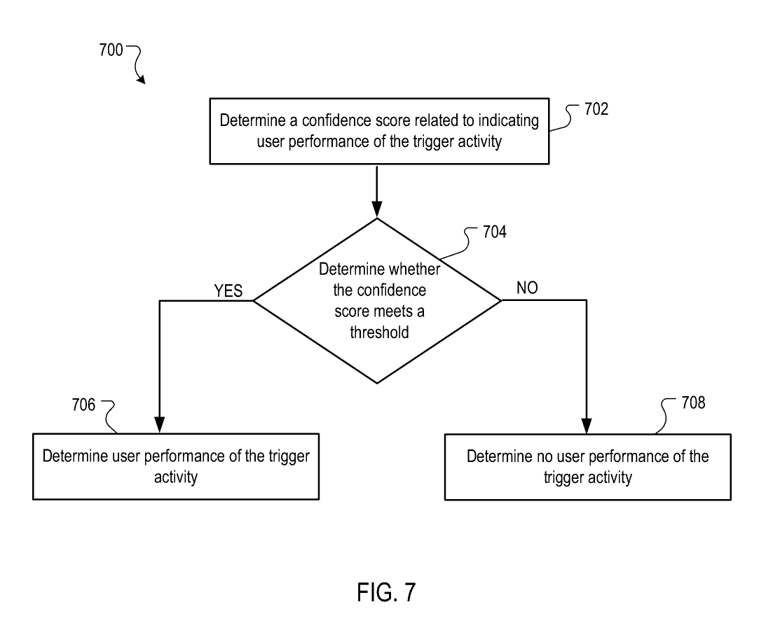

FIG. 7 is also a flow diagram of an example process 700 for using a confidence score and confidence score threshold for determining user performance of the trigger activity. The process 700 can, for example, be implemented by the user device 106 and/or action processor 124. In some implementations, the operations of the example process 700 can be implemented as instructions stored on a non-transitory computer readable medium, where the instructions cause a data processing apparatus to perform operations of the example process 700.

In example process 700, to determine user performance of the trigger activity, a confidence score may be determined for indicating a level of confidence of user performance of the trigger activity (702). For example, a confidence score may be determined for the trigger activity of “cooking” by the action processor 124 when the user context includes the user device 106 having a webpage open with a recipe in the viewport of the user device 106. A higher confidence score may be determined if the user calendar on the user device 106 indicates, for example, the user is scheduled to make dinner with “Larry” at this particular time. Moreover, an even higher confidence score could be determined if a person proximity condition related to “Larry” were included in the action item, and the action processor 124 determines that the user device of “Larry” is within the proximity range of the user device 106 associated with the user.

In order to determine user performance of the trigger activity, a determination may be made as to whether the confidence score meets the confidence score threshold (704). If the confidence score meets the confidence score threshold, then the action processor 124 and/or the user device 106 may determine user performance of the trigger activity (706). However, if the confidence score does not meet the confidence score threshold, a determination may be made there has not been user performance of the trigger activity (708). In that case, the action processor 124 and/or user device 106 may continue to monitor the user information and the environmental conditions to determine whether there has been user performance of the trigger activity by the user of the user device 106.

In situations in which the systems discussed herein collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

FIG. 8 is a block diagram of example mobile computing device. In this illustration, the mobile computing device 810 is depicted as a handheld mobile telephone (e.g., a smartphone, or an application telephone) that includes a touchscreen display device 812 for presenting content to a user of the mobile computing device 810 and receiving touch-based user inputs. Other visual, tactile, and auditory output components may also be provided (e.g., LED lights, a vibrating mechanism for tactile output, or a speaker for providing tonal, voice-generated, or recorded output), as may various different input components.

Example visual output mechanism in the form of display device 812 may take the form of a display with resistive or capacitive touch capabilities. The display device may be for displaying video, graphics, images, and text, and for coordinating user touch input locations with the location of displayed information so that the device 810 can associate user contact at a location of a displayed item with the item. The mobile computing device 810 may also take alternative forms, including as a laptop computer, a tablet or slate computer, a personal digital assistant, an embedded system (e.g., a car navigation system), a desktop personal computer, or a computerized workstation.

The mobile computing device 810 may be able to determine a position of physical contact with the touchscreen display device 812 (e.g., a position of contact by a finger or a stylus). Using the touchscreen 812, various “virtual” input mechanisms may be produced, where a user interacts with a graphical user interface element depicted on the touchscreen 512 by contacting the graphical user interface element. An example of a “virtual” input mechanism is a “software keyboard,” where a keyboard is displayed on the touchscreen and a user selects keys by pressing a region of the touchscreen 812 that corresponds to each key.

The mobile computing device 810 may include mechanical or touch sensitive buttons 818a-d. Additionally, the mobile computing device may include buttons for adjusting volume output by the one or more speakers 820, and a button for turning the mobile computing device on or off. A microphone 822 allows the mobile computing device 810 to convert audible sounds into an electrical signal that may be digitally encoded and stored in computer-readable memory, or transmitted to another computing device. The mobile computing device 810 may also include a digital compass, an accelerometer, proximity sensors, and ambient light sensors.

An operating system may provide an interface between the mobile computing device's hardware (e.g., the input/output mechanisms and a processor executing instructions retrieved from computer-readable medium) and software. The operating system may provide a platform for the execution of application programs that facilitate interaction between the computing device and a user.

The mobile computing device 810 may present a graphical user interface with the touchscreen 812. A graphical user interface is a collection of one or more graphical interface elements and may be static (e.g., the display appears to remain the same over a period of time), or may be dynamic (e.g., the graphical user interface includes graphical interface elements that animate without user input).

A graphical interface element may be text, lines, shapes, images, or combinations thereof. For example, a graphical interface element may be an icon that is displayed on the desktop and the icon's associated text. In some examples, a graphical interface element is selectable with user-input. For example, a user may select a graphical interface element by pressing a region of the touchscreen that corresponds to a display of the graphical interface element. In some examples, the user may manipulate a trackball to highlight a single graphical interface element as having focus. User-selection of a graphical interface element may invoke a pre-defined action by the mobile computing device. User-selection of the button may invoke the pre-defined action.

The mobile computing device 810 may include other applications, computing sub-systems, and hardware. A voice recognition service 872 may receive voice communication data received by the mobile computing device's microphone 822, and translate the voice communication into corresponding textual data or perform voice recognition. The processed voice data can be input to the command models stored in the command models data 122 to determine whether the voice input used to generate the voice data invokes a particular action for a particular application as described above. One or more of the applications, services and units below may have corresponding actions invoked by such voice commands.

A call handling unit may receive an indication of an incoming telephone call and provide a user the capability to answer the incoming telephone call. A media player may allow a user to listen to music or play movies that are stored in local memory of the mobile computing device 810. The mobile device 810 may include a digital camera sensor, and corresponding image and video capture and editing software. An internet browser may enable the user to view content from a web page by typing in an addresses corresponding to the web page or selecting a link to the web page.

A service provider that operates the network of base stations may connect the mobile computing device 810 to the network 850 to enable communication between the mobile computing device 810 and other computing systems that provide services 860. Although the services 860 may be provided over different networks (e.g., the service provider's internal network, the Public Switched Telephone Network, and the Internet), network 850 is illustrated as a single network. The service provider may operate a server system 852 that routes information packets and voice data between the mobile computing device 810 and computing systems associated with the services 860.

The network 850 may connect the mobile computing device 810 to the Public Switched Telephone Network (PSTN) 862 in order to establish voice or fax communication between the mobile computing device 810 and another computing device. For example, the service provider server system 852 may receive an indication from the PSTN 862 of an incoming call for the mobile computing device 810. Conversely, the mobile computing device 810 may send a communication to the service provider server system 852 initiating a telephone call using a telephone number that is associated with a device accessible through the PSTN 862.

The network 850 may connect the mobile computing device 810 with a Voice over Internet Protocol (VoIP) service 864 that routes voice communications over an IP network, as opposed to the PSTN. For example, a user of the mobile computing device 810 may invoke a VoIP application and initiate a call using the program. The service provider server system 852 may forward voice data from the call to a VoIP service, which may route the call over the internet to a corresponding computing device, potentially using the PSTN for a final leg of the connection.

An application store 866 may provide a user of the mobile computing device 810 the ability to browse a list of remotely stored application programs that the user may download over the network 850 and install on the mobile computing device 810. The application store 866 may serve as a repository of applications developed by third-party application developers. An application program that is installed on the mobile computing device 810 may be able to communicate over the network 850 with server systems that are designated for the application program. For example, a VoIP application program may be downloaded from the Application Store 866, enabling the user to communicate with the VoIP service 864.

The mobile computing device 810 may access content on the internet 868 through network 850. For example, a user of the mobile computing device 810 may invoke a web browser application that requests data from remote computing devices that are accessible at designated universal resource locations. In various examples, some of the services 860 are accessible over the internet.

The mobile computing device may communicate with a personal computer 870. For example, the personal computer 870 may be the home computer for a user of the mobile computing device 810. Thus, the user may be able to stream media from his personal computer 870. The user may also view the file structure of his personal computer 870, and transmit selected documents between the computerized devices.

The mobile computing device 810 may communicate with a social network 874. The social network may include numerous members, some of which have agreed to be related as acquaintances. Application programs on the mobile computing device 810 may access the social network 874 to retrieve information based on the acquaintances of the user of the mobile computing device. For example, an “address book” application program may retrieve telephone numbers for the user's acquaintances. In various examples, content may be delivered to the mobile computing device 810 based on social network distances from the user to other members in a social network graph of members and connecting relationships. For example, advertisement and news article content may be selected for the user based on a level of interaction with such content by members that are “close” to the user (e.g., members that are “friends” or “friends of friends”).

The mobile computing device 810 may access a personal set of contacts 876 through network 850. Each contact may identify an individual and include information about that individual (e.g., a phone number, an email address, and a birthday). Because the set of contacts is hosted remotely to the mobile computing device 810, the user may access and maintain the contacts 876 across several devices as a common set of contacts.

The mobile computing device 810 may access cloud-based application programs 878. Cloud-computing provides application programs (e.g., a word processor or an email program) that are hosted remotely from the mobile computing device 810, and may be accessed by the device 810 using a web browser or a dedicated program.

Mapping service 880 can provide the mobile computing device 810 with street maps, route planning information, and satellite images. The mapping service 880 may also receive queries and return location-specific results. For example, the mobile computing device 810 may send an estimated location of the mobile computing device and a user-entered query for “pizza places” to the mapping service 880. The mapping service 880 may return a street map with “markers” superimposed on the map that identify geographical locations of nearby “pizza places.”

Turn-by-turn service 882 may provide the mobile computing device 810 with turn-by-turn directions to a user-supplied destination. For example, the turn-by-turn service 882 may stream to device 810 a street-level view of an estimated location of the device, along with data for providing audio commands and superimposing arrows that direct a user of the device 810 to the destination.

Various forms of streaming media 884 may be requested by the mobile computing device 810. For example, computing device 810 may request a stream for a pre-recorded video file, a live television program, or a live radio program.

A micro-blogging service 886 may receive from the mobile computing device 810 a user-input post that does not identify recipients of the post. The micro-blogging service 886 may disseminate the post to other members of the micro-blogging service 886 that agreed to subscribe to the user.

A search engine 888 may receive user-entered textual or verbal queries from the mobile computing device 810, determine a set of internet-accessible documents that are responsive to the query, and provide to the device 810 information to display a list of search results for the responsive documents. In examples where a verbal query is received, the voice recognition service 872 may translate the received audio into a textual query that is sent to the search engine.

These and other services may be implemented in a server system 890. A server system may be a combination of hardware and software that provides a service or a set of services. For example, a set of physically separate and networked computerized devices may operate together as a logical server system unit to handle the operations necessary to offer a service to hundreds of computing devices. A server system is also referred to herein as a computing system.

In various implementations, operations that are performed “in response to” or “as a consequence of” another operation (e.g., a determination or an identification) are not performed if the prior operation is unsuccessful (e.g., if the determination was not performed). Operations that are performed “automatically” are operations that are performed without user intervention (e.g., intervening user input). Features in this document that are described with conditional language may describe implementations that are optional. In some examples, “transmitting” from a first device to a second device includes the first device placing data into a network for receipt by the second device, but may not include the second device receiving the data. Conversely, “receiving” from a first device may include receiving the data from a network, but may not include the first device transmitting the data.

“Determining” by a computing system can include the computing system requesting that another device perform the determination and supply the results to the computing system. Moreover, “displaying” or “presenting” by a computing system can include the computing system sending data for causing another device to display or present the referenced information.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a user computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method, comprising:
receiving, at a user device, input of a user defined action by a user of the user device, the user defined action including a plurality of terms input by the user of the user device;
receiving, by the user device, a selection of a user defined trigger activity selected by the user of the user device, the trigger activity indicating user performance of an activity that is different from the user defined action;
associating, by the user device, the user defined trigger activity with the user defined action, wherein the association causes the user device to determine a current user performance of the activity indicated by the user defined trigger activity and to trigger the user defined action to be presented in response to determining user performance of the activity indicated by the user defined trigger activity;
determining, based on sensor data provided from environmental sensors within the user device, at least one environmental condition of an environment in which the user device is located;
receiving, from a data source that is separate from the environmental sensors of the user device, user information that includes data that describes a current context that is different from prior activities performed by the user and that is different from environment conditions of the environment in which the user device is located;
determining, based on the context described by the user information and the at least one environmental condition, the current user performance of the activity indicated by the trigger activity; and
presenting, by the user device, a notification of the user defined action.

2. The method of claim 1, wherein the user defined action is a reminder task, and the trigger activity is at least one of a physical activity and a situational activity.

3. The method of claim 1, further comprising at least one activity condition, wherein the determining the user performance of the activity indicated by the trigger activity further includes:
receiving, by the user device, a selection of at least one activity condition, the at least one activity condition indicating a condition to be satisfied in determining the user performance of the activity indicated by the trigger activity;
determining, by the user device, the at least one activity condition;
determining, by the user device, that the at least one activity condition has been satisfied; and
determining, based on user information and the at least one environmental condition, user performance of the activity indicated by the trigger activity.

4. The method of claim 3, wherein the at least one activity condition is at least one of a time period condition, a location area condition, and a person proximity condition.

5. The method of claim 1, wherein determining the at least one environmental condition of an environment in which the user device is located, further comprises:
determining, by the environmental sensors within the user device and at a first time, the environment in which the user device is located;
determining, by the environmental sensors within the user device and at a second time, the environment in which the user device is located; and
determining, by the user device, at least one environmental condition of the environment in which the user device is located based on the environment of at least the first time and the second time.

6. The method of claim 1, wherein presenting the notification of the user defined action to the user device of the user, further comprises:
performing, by the user device, the user defined action; and
presenting, by the user device, a notification that the user defined action has been performed.

7. The method of claim 1, wherein determining, based on user information and the at least one environmental condition, the current user performance of the activity indicated by the trigger activity further comprises:
determining, from the context that is different from prior activities performed by the user and different from environment conditions of the environment in which the user device is located, indicators of current performance of the activity indicated by trigger activity;
determining, based at least in part on the indicators of the current performance of the activity indicated by trigger activity, a confidence score indicating a level of confidence of current user performance of the activity indicated by the trigger activity;
determining that the confidence score meets a confidence score threshold.

8. A user device, comprising:
a processor;
environmental sensors coupled to the processors; and
a computer-readable medium coupled to the processor and having instructions stored thereon, which, when executed by the processor, cause the processor to perform operations comprising:
receiving input of a user defined action input by a user of the user device, the user defined action including a plurality of terms input by the user of the user device;
receiving a selection of a user defined trigger activity selected by the user of the user device, the trigger activity indicating user performance of an activity that is different from the user defined action;
associating the user defined trigger activity with the user defined action, wherein the association causes the user device to determine a current user performance of the activity indicated by the user defined trigger activity and to trigger the user defined action to be presented in response to determining user performance of the activity indicated by the user defined trigger activity;
determining, based on sensor data provided from the environmental sensors, at least one environmental condition of an environment in which the user device is located;
receiving, from a data source that is separate from the environmental sensors of the user device, user information that includes data that describes a current context that is different from prior activities performed by the user and that is different from environment conditions of the environment in which the user device is located;
determining, based on the context described by the user information and the at least one environmental condition, the current user performance of the activity indicated by the trigger activity; and
presenting a notification of the user defined action by the user device.

9. The user device of claim 8, wherein the user defined action is a reminder task, and the trigger activity is at least one of a physical activity and a situational activity.

10. The user device of claim 8, further comprising at least one activity condition, wherein the determining the user performance of the activity indicated by the trigger activity further includes:
receiving a selection of at least one activity condition, the at least one activity condition indicating a condition to be satisfied in determining the user performance of the activity indicated by the trigger activity;
determining the at least one activity condition;
determining that the at least one activity condition has been satisfied; and
determining, based on user information and the at least one environmental condition, user performance of the activity indicated by the trigger activity.

11. The user device of claim 10, wherein the at least one activity condition is at least one of a time period condition, a location area condition, and a person proximity condition.

12. The user device of claim 8, wherein determining the at least one environmental condition of an environment in which the user device is located, further comprises:
determining, by the environmental sensors within the user device and at a first time, the environment in which the user device is located;
determining, by the environmental sensors within the user device and at a second time, the environment in which the user device is located; and
determining, by the user device, at least one environmental condition of the environment in which the user device is located based on the environment of at least the first time and the second time.

13. The user device of claim 8, wherein presenting the notification of the user defined action further comprises:
performing the user defined action; and
presenting a notification that the user defined action has been performed.

14. The user device of claim 8, wherein determining, based on user information and the at least one environmental condition, the user performance of the activity indicated by the trigger activity further comprises:
determining, from the context that is different from prior activities performed by the user and different from environment conditions of the environment in which the user device is located, indicators of current performance of the activity indicated by trigger activity;
determining, based at least in part on the indicators of the current performance of the activity indicated by trigger activity, a confidence score indicating a level of confidence of current user performance of the activity indicated by the trigger activity;
determining that the confidence score meets a confidence score threshold.

15. A computer-readable medium having instructions stored thereon, which, when executed by a processor of a user device, cause the user device to perform operations, comprising:
receiving input of a user defined action input by a user of the user device, the user defined action including a plurality of terms input by the user of the user device;
receiving a selection of a user defined trigger activity selected by the user of the user device, the trigger activity indicating user performance of an activity that is different from the user defined action;
associating the user defined trigger activity with the user defined action, wherein the association causes the user device to determine a current user performance of the activity indicated by the user defined trigger activity and to trigger the user defined action to be presented in response to determining user performance of the activity indicated by the user defined trigger activity;
determining, based on sensor data provided from the environmental sensors, at least one environmental condition of an environment in which the user device is located;
receiving, from a data source that is separate from the environmental sensors of the user device, user information that includes data that describes a current context that is different from prior activities performed by the user and that is different from environment conditions of the environment in which the user device is located;
determining, based on the context described by the user information and the at least one environmental condition, the current user performance of the activity indicated by the trigger activity; and
presenting a notification of the user defined action by the user device.

16. The computer-readable medium of claim 15, further comprising at least one activity condition, wherein the determining the user performance of the activity indicated by the trigger activity further includes:
receiving a selection of at least one activity condition, the at least one activity condition indicating a condition to be satisfied in determining the user performance of the activity indicated by the trigger activity;
determining the at least one activity condition;
determining that the at least one activity condition has been satisfied; and
determining, based on user information and the at least one environmental condition, user performance of the activity indicated by the trigger activity.

17. The computer-readable medium of claim 15, wherein determining environmental conditions of an environment in which the user device is located, further comprises:
determining, by the environmental sensors within the user device and at a first time, the environment in which the user device is located;
determining, by the environmental sensors within the user device and at a second time, the environment in which the user device is located; and
determining, by the user device, at least one environmental condition of the environment in which the user device is located based on the environment of at least the first time and the second time.

18. The computer-readable medium of claim 15, wherein presenting the notification of the user defined action, further comprises:
performing the user defined action; and
presenting a notification that the user defined action has been performed.

19. The computer-readable medium of claim 15, wherein determining, based on user information and the environmental conditions, the user performance of the activity indicated by the trigger activity further comprises:
determining, from the context that is different from prior activities performed by the user and different from environment conditions of the environment in which the user device is located, indicators of current performance of the activity indicated by trigger activity;
determining, based at least in part on the indicators of the current performance of the activity indicated by trigger activity, a confidence score indicating a level of confidence of current user performance of the activity indicated by the trigger activity;
determining that the confidence score meets a confidence score threshold.

20. (canceled)

21. The method of claim 1, wherein the context includes actions the user is performing on the user device and applications that are opened or being used on the user device.

22. (canceled)

23. The user device of claim 10, wherein the context includes actions the user is performing on the user device and applications that are opened or being used on the user device.

24. (canceled)
